(19) United States
(12) Patent Application Publication
(10) Pub. No.: US 2024/0190034 A1
(43) Pub. Date: Jun. 13, 2024

(54) ADJUSTABLE FLIP STOP

(71) Applicant: Hui-Chuan Liao, Oakland, CA (US)

(72) Inventors: Hui-Chuan LIAO, Oakland, CA (US); Chun-Ti Wang, Taichung City (TW)

(21) Appl. No.: 18/079,868

(22) Filed: Dec. 12, 2022

(51) Int. Cl. B27B 27/10

(52) U.S. Cl. CPC B27B 27/10

(57) ABSTRACT

An adjustable flip stop has a body, a fixing component, and a flip arm. The fixing component has a bolt and a nut. The bolt is mounted through a fixing hole of the body and has a bolt head contained in an interior of a T-track, and the nut is threaded with the bolt to locate the body between the bolt head and the nut. The flip arm has a connecting element, an arm body, and an adjusting element. The connecting element is pivotally connected to the body, and the arm body has a longitudinal direction. The adjusting element is combined with the connecting element and is capable of being combined at different positions of the arm body in the longitudinal direction to make the arm body and the connecting element fixed with respect to each other. The adjustable flip stop is applicable with fences of different heights.

### BACKGROUND OF THE INVENTION

### 1. Field of the Invention

The present invention relates to a wood working tool, and particularly to an adjustable flip stop.

### 2. DESCRIPTION OF RELATED ART

Wood working relates to skills and craft of cutting and processing wood. Recently, with the trend of doing it yourself (DIY) and returning to nature, more and more people begin to engage in the field of wood working.

In the wood working field, table saws and rotary saw machines are common devices for cutting wood, and normally, a fence, a T-track, and a flip stop are used in cooperation for positioning wood before cutting. The fence is normally a structure being rectangular in shape, having a certain height, and extending horizontally. The T-track is stably located on the fence. The flip stop mainly has a body, a fixing component, and a flip arm. The fixing component has a bolt and a nut. The bolt is mounted through the body and has a bolt head being containable in an interior of the T-track and allowing the flip stop to slide along the T-track. The nut is threaded with the bolt and is capable of pressing the body against the T-track to make the flip stop and the T-track fixed with respect to each other. The flip arm is pivotally connected to the body.

In use, a tape measure is disposed on the fence or the T-track, and the flip stop has an aligning construction for being aligned with a graduation on the tape measure; the aligning construction may be a needle pointer or a simple notch. When the flip stop slides along the T-track, the aligning construction is aligned with the graduation on the tape measure, and the position of the flip stop can thus be acquired. After the flip stop is moved to an appropriate position according to a desired size into which the wood will be cut, the flip stop and the T-track are fixed with respect to each other by the pressing of the nut which is threaded with the bolt. Then, the flip arm is actuated to pivot relative to the body and abuts a side of the fence. Finally, the wood first abuts the fence and then is moved along the fence to abut the flip arm. Thereby, the wood can be positioned at the correct place for being cut into a piece of the desired size.

However, a conventional flip stop on the market has the flip arm being a single member and having a fixed size. When the wood pieces and blocks of wood for being cut have different heights, the fences of different heights should be used alternatively according to the heights of the wood. However, if a length of the flip arm is larger than a height of the fence, the flip arm first abuts a surface where the fence is disposed and cannot abut the fence after pivoting; if a length of the flip arm is shorter than a height of the fence after the change of the fence, only a small part of the wood abuts the flip arm when positioning, which leads to inaccuracy of positioning. Thereby, the conventional flip stop cannot be used with fences of different heights and is inconvenient.

To overcome the shortcomings of the conventional flip stop, the present invention tends to provide an adjustable flip stop to mitigate or obviate the aforementioned problems.

### SUMMARY OF THE INVENTION

The main objective of the present invention is to provide an adjustable flip stop that has a flip arm being adjustable and can be used with fences of different heights.

The adjustable flip stop has a body, a fixing component, and a flip arm. The body has a fixing hole. The fixing component has a bolt and a nut. The bolt is mounted through the fixing hole of the body and has a bolt head being containable in an interior of a T-track, and the nut is configured to be threaded with the bolt to locate the body between the bolt head of the bolt and the nut. The flip arm has a connecting element, an arm body, and an adjusting element. The connecting element is pivotally connected to the body, and the arm body has a longitudinal direction. The adjusting element is configured to be combined with the connecting element and configured to be combined at different positions of the arm body in the longitudinal direction to make the arm body and the connecting element fixed with respect to each other.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an adjustable flip stop of a preferred embodiment in accordance with the present invention;

FIG. 2 is an exploded view of the adjustable flip stop in FIG. 1;

FIGS. 3 and 4 are operational side views of the adjustable flip stop in FIG. 1;

FIG. 5 is an operational perspective view of the adjustable flip stop in FIG. 1; and

FIG. 6 is another operational side view of the adjustable flip stop in FIG. 1.

### DETAILED DESCRIPTION OF THE PREFERRED EMBODIMENT

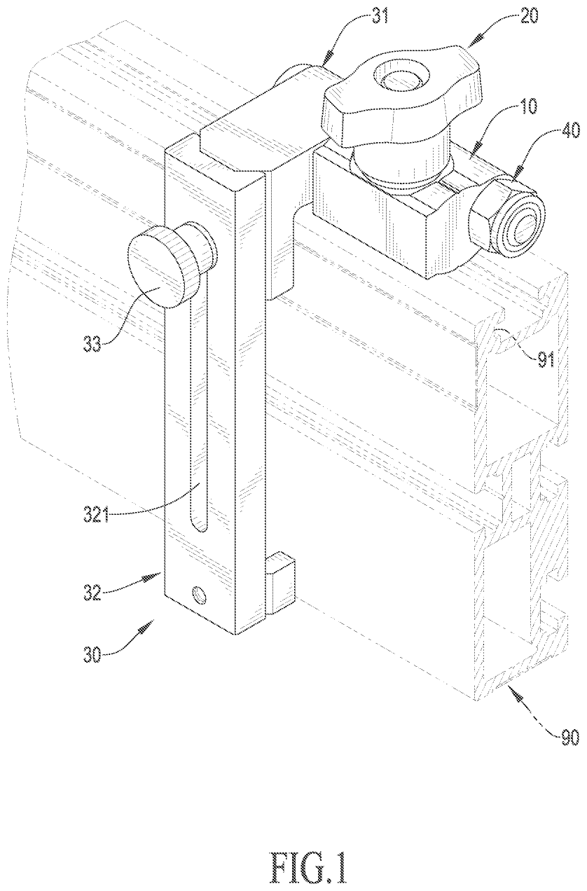

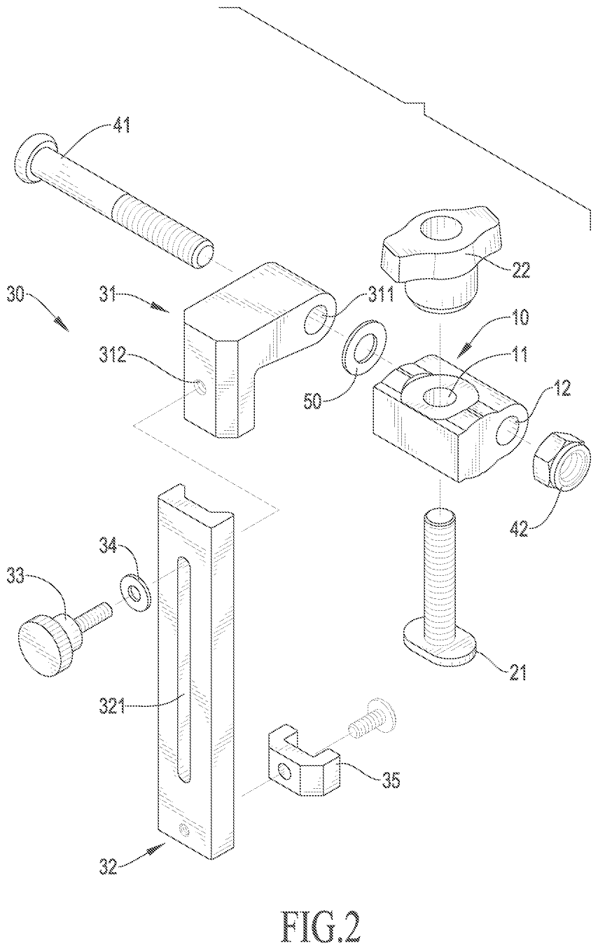

With reference to FIGS. 1 and 2, an adjustable flip stop of a preferred embodiment in accordance with the present invention has a body 10, a fixing component 20, and a flip arm 30.

With reference to FIG. 2, the body 10 has a fixing hole 11 and a pivoting hole 12 which are both defined through the body 10. The fixing hole 11 has an extending direction, and the pivoting hole 12 has an extending direction being perpendicular to the extending direction of the fixing hole 11.

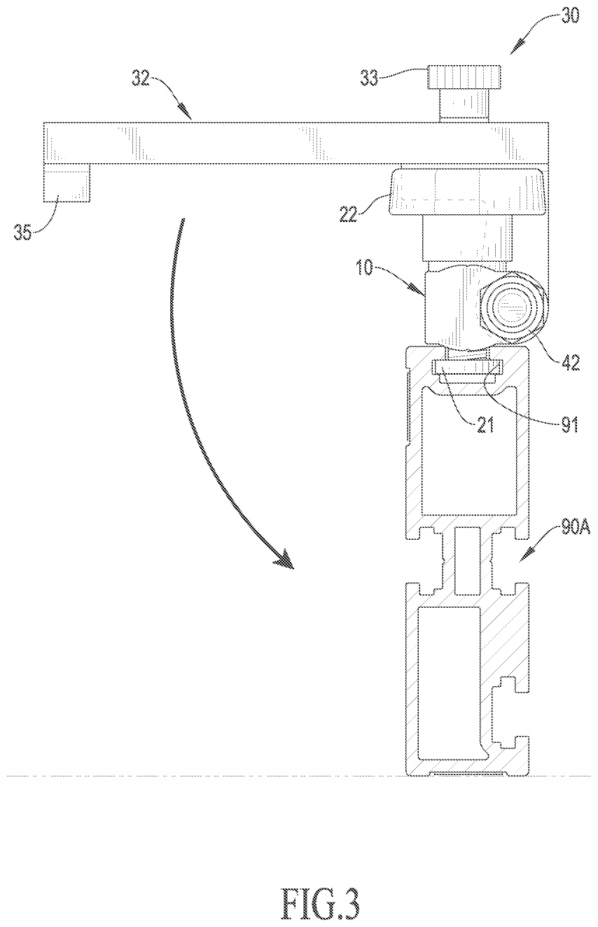

With reference to FIG. 2, the fixing component 20 has a bolt 21 and a nut 22. The bolt 21 is mounted through the fixing hole 11 of the body 10 and has a bolt head. With reference to FIG. 3, the bolt head of the bolt 21 matches an interior of a T-track 91 and is configured to be contained in the interior of the T-track 91 to allow the adjustable flip stop to slide along the T-track 91. With reference to FIGS. 1 and 3, the T-track 91 is a portion of a fence 90(90A) made by aluminum extrusion. Specifically, the bolt head of the bolt 21 can be inserted into the interior of the T-track 91 from one of two openings of the T-track 91 which are respectively formed on two opposite ends of the fence 90(90A). With reference to FIGS. 1 and 3, the nut 22 is configured to be threaded with the bolt to locate the body 10 between the bolt head of the bolt 21 and the nut 22. The nut 22 is capable of approaching the bolt 21 when being turned, and the nut 22 and the bolt head of the bolt 21 are able to clamp the body 10 and the T-track 91 together to make the body 10 and the T-track 91 fixed with respect to each other.

With reference to FIGS. 1 and 2, the flip arm 30 has a connecting element 31, an arm body 32, and an adjusting element 33. The connecting element 31 is block-shaped and is pivotally connected to the body 10. In the preferred embodiment, the connecting element 31 is pivotally connected to the body 10 via a pivot component 40. Specifically, with reference to FIG. 2, the connecting element 31 has a pivot hole 311, and the pivot component 40 has a pivot bolt 41 and a pivot nut 42. The pivot bolt 41 is mounted through the pivot hole 311 of the connecting element 31, is mounted through the pivoting hole 12 of the body 10, and is threaded with the pivot nut 42. Thereby, the connecting element 31 is pivotally connected to the body 10. In other embodiments, the pivoting hole 12 can be a screw hole, and the pivot bolt 41 can be threaded into the pivoting hole 12 to allow the connecting element 31 to be pivotally connected to the body 10.

With reference to FIG. 2, in this preferred embodiment, the adjustable flip stop further has a washer 50, and the washer 50 has a through hole defined through a middle of the washer 50. The pivot bolt 41 is sequentially mounted through the pivot hole 311, the through hole of the washer 50, and the pivoting hole 12 and is threaded with the pivot nut 42. The washer 50 is clamped between the connecting element 31 and the body 10 and is able to reduce abrasion of the connecting element 31 and the body 10.

With reference to FIG. 2, the arm body 32 is elongated, has a longitudinal direction, and has an elongated hole 321 defined through the arm body 32. The elongated hole 321 extends along the longitudinal direction of the arm body 32. The connecting element 31 has a combing hole 312. The adjusting element 33 is configured to be mounted through any position in the elongated hole 321 and detachably combined with the connecting element 31 via the combing hole 312. Thus, the adjusting element 33 and the connecting element 31 are capable of clamping the arm body 32 together to make the arm body 32 and the connecting element 31 fixed with respect to each other.

In this preferred embodiment, the combing hole 312 of the connecting element 31 is a screw hole, and the adjusting element 33 is a knob screw for the convenience of operation. In other embodiments, the combing hole 312 and the adjusting element 33 can be a mortise and tenon structure or a fastening hole and a corresponding fastening unit if the adjusting element 33 is capable of being mounted through the elongated hole 321 and being combined in the combing hole 312 to clamp the arm body 32 with the connecting element 31.

In this preferred embodiment, the flip arm 30 further has a filling washer 34. The adjusting element 33 is sequentially mounted through the filling washer 34 and the elongated hole 321 and is combined with the connecting element 31 via the combing hole 312. Thus, the filling washer 34 is clamped between the adjusting element 33 and the arm body 32 and is able to prevent a surface of the arm body 32 from being scraped by the adjusting element 33.

The operation of the adjustable flip stop is described as follows. With reference to FIG. 3, first, the adjustable flip stop is mounted onto the T-track 91 of a first fence 90A. In the preferred embodiment, the T-track 91 is a portion of the first fence 90A made by aluminum extrusion. In other embodiments, the T-track 91 and the first fence 90A may also be two individual components. After the bolt head of the bolt 21 is contained in the interior of the T-track 91, the adjustable flip stop can be moved along the T-track 91. Next, the adjustable flip stop is moved along the T-track 91 to a setting position according to a desired size of the wood to be cut. Specifically, a tape measure is disposed on the first fence 90A or the T-track 91, and the adjustable flip stop has an aligning construction for being aligned with a graduation on the tape measure. Thereby, the adjustable flip stop can be moved to the setting position by the aligning construction. Since the configuration above is conventional, the detail is neither shown in the figure nor described here.

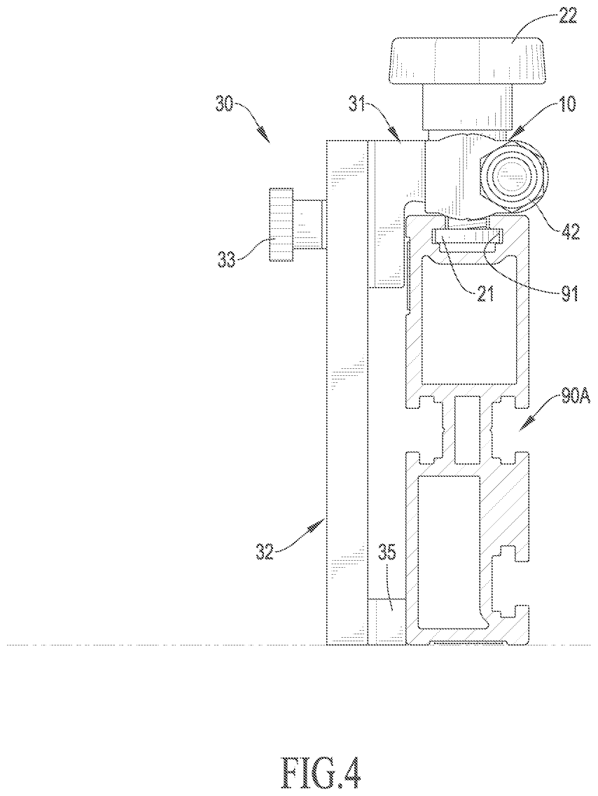

After the adjustable flip stop is moved to the setting position according to the desired size, the nut 22 is turned and approaches the bolt 21 to make the body 10 and the T-track 91 fixed with respect to each other and prevent the body from randomly moving away from the setting position. Then, with reference to FIGS. 3 and 4, the flip arm 30 is actuated to pivot relative to the body 10 and abuts the first fence 90A. In this preferred embodiment, the flip arm 30 further has a fence-abutting block 35, and the arm body 32 has two opposite ends in the longitudinal direction. The fence-abutting block 35 is detachably mounted on one of the two opposite ends of the arm body 32 and specifically is screwed on the arm body 32 via bolts. After actuating the flip arm 30 to pivot relative to the body 10, the flip arm 30 abuts the first fence 90A with the fence-abutting block 35. When the adjustable flip stop is used with fences of different widths, the flip arm 30 is still able to stably abut any one of those fences by replacing fence-abutting blocks 35 of different sizes.

After the flip arm 30 abuts the first fence 90A, wood W for cutting is first attached to the first fence 90A and is moved along the first fence 90A to abut against the flip arm 30. Therefore, the wood W is positioned at the right place for cutting. Last, the first fence 90A and the wood W are pushed toward a saw blade, and the wood W is finally cut into a piece of the desired size.

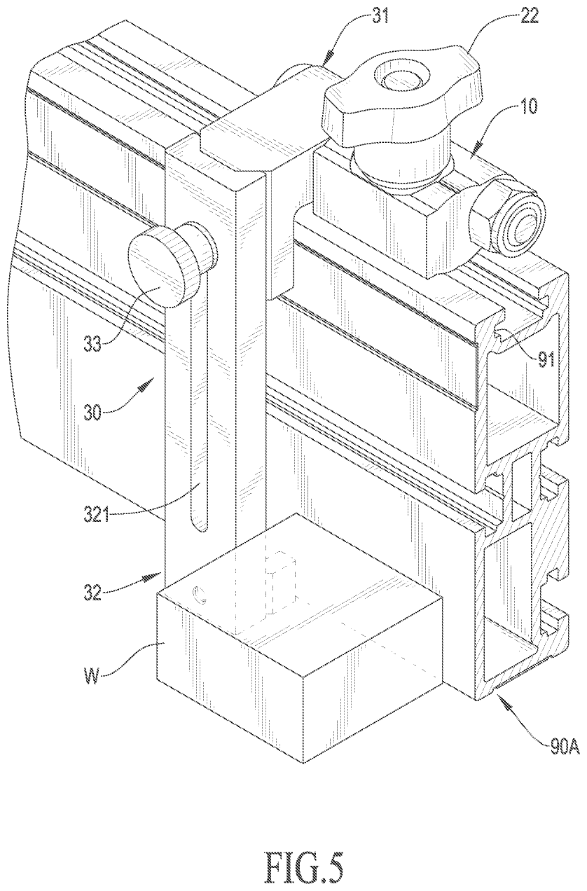

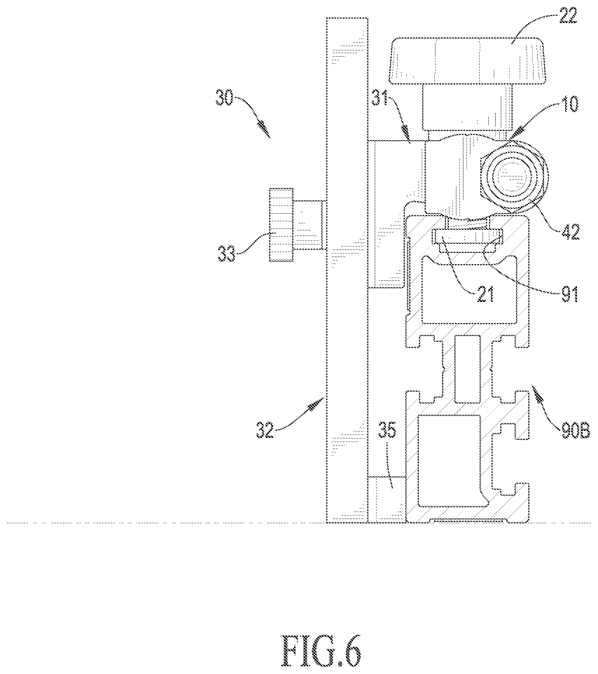

Fences of different heights are used according to the sizes of the wood for cutting. With reference to FIG. 6, a second fence 90B having a smaller height compared to the first fence 90A in FIGS. 3 to 5 is adopted. The operation of the adjustable flip stop is almost same as described above. The difference is that the flip arm 30 needs to be adjusted first. When the second fence 90B is adopted after the first fence 90A, the adjusting element 33 is detached from the combining hole 312 first, is mounted through another position in the elongated hole 321, and is finally combined with the connecting element 31 via the combining hole again. Specifically, the position in the elongated hole 321 through which the adjusting element 33 is mounted moves from an end of the elongated hole 321 to a middle portion of the elongated hole 321. As a result, a portion of the arm body 32 which approaches the second fence 90B as the flip arm 30 pivots is shorter than a portion of the arm body 32 which approaches the first fence 90A as the flip arm 30 pivots. When the flip arm 30 pivots relative to the body 10, the arm body 32 abuts the second fence 90B successfully and does not abut against a surface of a saw table where the second fence 90B is disposed. The adjustable flip stop is still applicable for positioning. Thereby, the adjustable flip stop can be used with fences of different heights.

When the adjustable flip stop is used with fences of different heights, just as the operation described above, the adjusting element 33 is detached from the combining hole 312 first and is mounted through another position in the elongated hole 321. In the preferred embodiment, a user can loosen the adjusting element 33 being a knob screw from the combining hole 312 being a screw hole manually and actuate the arm body 32 to move for adjusting the position in the elongated hole 321 through which the adjusting element 33 is mounted. Finally, the adjusting element 33 is tightened and combined with the connecting element 31 via the combining hole 312. A length of a portion of the arm body 32 which approaches the fence as the flip arm 30 pivots can thus be adjusted, which allows the adjustable flip stop to be used with fences of different heights.

The conventional flip stop has a flip arm being a single member pivotally connected to the body and having a fixed size and thus cannot be used with fences of different heights. In comparison, the adjustable flip stop in the present invention has the flip arm 30 having the connecting element 31, the arm body 32, and the adjusting element 33 to allow a user to quickly and easily adjust the length of the portion of the arm body 32 which approaches the fence as the flip arm 30 pivots. Thereby, the adjustable flip stop can be used with fences of different heights for positioning wood before cutting.

In this preferred embodiment, the adjusting element 33 being a knob screw is mounted through the elongated hole 321 and combined with the connecting element 31 via the combining hole 312 being a screw hole. In other embodiments, the connecting element 31 and the adjusting element 33 may adopt the configurations of the mortise and tenon structure or other fastening components. Furthermore, the connecting element 31 may have a tenon structure, a bolt, or a fastening unit to be mounted through the elongated hole 321 and combined with a mortise structure, a screw hole, or a fastening hole on the adjusting element 33. The effects of the present invention can still be achieved with all the configurations above.

In the preferred embodiment and other embodiments described above, the arm body 32 has the elongated hole 321 for the adjusting element 33 or the connecting element 31 to be mounted through. In other embodiments, the adjusting element 33 and the connecting element 31 may both be made of magnetic materials, and the adjusting element 33 and the connecting element 31 can be respectively attached to two opposite sides of the arm body 32 and be magnetically attached to each other. By adjusting the position of the adjusting element 33 and the connecting element 31 attached to the arm body 32 in the longitudinal direction, the length of the portion of the arm body 32 which approaches the fence as the flip arm 30 pivots can be adjusted. Therefore, as long as the adjusting element 33 is capable of being combined with the connecting element 31 and is capable of being combined at different positions of the arm body 32 in the longitudinal direction of the arm body 32, the effects of the present invention can be achieved.

In other embodiments, the arm body 32 may have multiple adjusting holes instead of the elongated hole 321, and the multiple adjusting holes are arranged at spaced intervals in the longitudinal direction. The adjusting element 33 is capable of being mounted through different adjusting holes and being combined with the connecting element 31 via the combining hole 312 of the connecting element 31, and the length of the portion of the arm body 32 which approaches the fence as the flip arm 30 pivots can be adjusted. An advantage of the preferred embodiment is that the elongated hole 321 of the arm body 32 enlarges the range of adjusting, and the positions in the elongated hole 321 through which the adjusting element 33 is mounted are not limited as adopting the multiple adjusting holes.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An adjustable flip stop comprising:
a body having a fixing hole;
a fixing component having
a bolt mounted through the fixing hole of the body and having a bolt head being containable in an interior of a T-track; and
a nut configured to be threaded with the bolt to locate the body between the bolt head of the bolt and the nut; and
a flip arm having
a connecting element pivotally connected to the body;
an arm body having a longitudinal direction; and
an adjusting element configured to be combined with the connecting element and configured to be combined at different positions of the arm body in the longitudinal direction to make the arm body and the connecting element fixed with respect to each other.

2. The adjustable flip stop as claimed in claim 1, wherein
the arm body has an elongated hole extending along the longitudinal direction of the arm body;
the connecting element has a combining hole; and
the adjusting element is configured to be mounted through any position in the elongated hole, be combined with the connecting element via the combining hole of the connecting element, and clamp the arm body with the connecting element.

3. The adjustable flip stop as claimed in claim 2, wherein
the flip arm has a filling washer; and
the adjusting element is configured to be mounted through a through hole of the filling washer and the elongated hole of the arm body and to be mounted in the combining hole of the connecting element to make the filling washer clamped by the arm body and the adjusting element.

4. The adjustable flip stop as claimed in claim 2, wherein
the adjusting element is a knob screw; and
the combining hole of the connecting element is a screw hole.

5. The adjustable flip stop as claimed in claim 3, wherein
the adjusting element is a knob screw; and
the combining hole of the connecting element is a screw hole.

6. The adjustable flip stop as claimed in claim 1, wherein
the adjustable flip stop has a pivot component and a washer;
the pivot component combines the connecting element, the washer, and the body; and
the washer is clamped between the connecting element and the body.

7. The adjustable flip stop as claimed in claim 2, wherein
the adjustable flip stop has a pivot component and a washer;
the pivot component combines the connecting element, the washer, and the body; and
the washer is clamped between the connecting element and the body.

8. The adjustable flip stop as claimed in claim 3, wherein
the adjustable flip stop has a pivot component and a washer;
the pivot component combines the connecting element, the washer, and the body; and
the washer is clamped between the connecting element and the body.

9. The adjustable flip stop as claimed in claim 4, wherein
the adjustable flip stop has a pivot component and a washer;
the pivot component combines the connecting element, the washer, and the body; and
the washer is clamped between the connecting element and the body.

10. The adjustable flip stop as claimed in claim 5, wherein
the adjustable flip stop has a pivot component and a washer;
the pivot component combines the connecting element, the washer, and the body; and
the washer is clamped between the connecting element and the body.

11. The adjustable flip stop as claimed in claim 1, wherein
the arm body has two opposite ends in the longitudinal direction; and
the adjustable flip stop has a fence-abutting block detachably mounted on one of the two opposite ends of the arm body and being capable of abutting a fence as the flip arm pivots relative to the body.

12. The adjustable flip stop as claimed in claim 2, wherein
the arm body has two opposite ends in the longitudinal direction; and
the adjustable flip stop has a fence-abutting block detachably mounted on one of the two opposite ends of the arm body and being capable of abutting a fence as the flip arm pivots relative to the body.

13. The adjustable flip stop as claimed in claim 3, wherein
the arm body has two opposite ends in the longitudinal direction; and
the adjustable flip stop has a fence-abutting block detachably mounted on one of the two opposite ends of the arm body and being capable of abutting a fence as the flip arm pivots relative to the body.

14. The adjustable flip stop as claimed in claim 4, wherein
the arm body has two opposite ends in the longitudinal direction; and
the adjustable flip stop has a fence-abutting block detachably mounted on one of the two opposite ends of the arm body and being capable of abutting a fence as the flip arm pivots relative to the body.

15. The adjustable flip stop as claimed in claim 5, wherein
the arm body has two opposite ends in the longitudinal direction; and
the adjustable flip stop has a fence-abutting block detachably mounted on one of the two opposite ends of the arm body and being capable of abutting a fence as the flip arm pivots relative to the body.
